(19) United States
(12) Patent Application Publication
(10) Pub. No.: US 2009/0307265 A1
(43) Pub. Date: Dec. 10, 2009

(54) METHOD OF OPERATING A WAREHOUSE

(75) Inventors: Jerry Scott Nicholson, Fairburn, GA (US); Mark William Phillips, Fairburn, GA (US)

Correspondence Address: STANDLEY LAW GROUP LLP, 6300 Riverside Drive, Dublin, OH, 43017, US

(73) Assignee: EXEL INC., Westerville, OH (US)

(21) Appl. No.: 12/134,789

(22) Filed: Jun. 6, 2008

(51) Int. Cl. G06F 17/30

(52) U.S. Cl. 707/103 Y; 707/E17.055

(57) ABSTRACT

A method comprising the steps of: providing a database server having a database comprising real-time data related a warehouse object, the real-time data including data regarding the location of the warehouse object and data regarding the time and date the warehouse object became resident at the location, the real-time data populated in the database by warehouse management software; providing at least one rule related to when a condition of location for the warehouse object must cease, each rule having an associated trigger based on a lead time required to avoid violation of the rule; receiving data related to the warehouse object at a computer; predicting a potential violation of the rule by comparing, on the computer, data regarding the time-date the warehouse object became resident at the location with the trigger; generating an alarm related to a potential violation of the rule; and providing an alarm to an operator.

### TECHNICAL FIELD OF THE INVENTION

The present invention relates to methods for the efficient operation of a warehouse. Specifically, the present invention relates to proactive methods for operating a warehouse so as to optimize performance of operation of the warehouse by monitoring variables in real-time versus benchmarks.

### BACKGROUND OF THE INVENTION

As used herein, the term “warehouse object” shall mean goods, items, inventory or any other object or thing within a warehouse.

As used herein, the term “user device” shall mean a PDA, computer, cell phone, smart phone or pager.

As used herein, the term “freight transportation vehicle” shall mean any of a number of vehicles capable of transporting items or goods from one location to another including, without limitation, semi-tractor trailers, cargo vans, and flat bed trucks.

As used herein, the term “staging area” shall mean a location within the warehouse where materials are temporarily placed when received from a freight transportation vehicle or where materials are temporarily placed prior to loading them onto a freight transportation vehicle.

As used herein, the term “storage area” shall mean a location within the warehouse where materials are stored in a more long-term fashion than in a staging area.

A warehouse management system, or WMS, is a key part of the supply chain and primarily aims to control the movement and storage of materials within a warehouse and process the associated transactions, including shipping, receiving, putaway and picking. Warehouse management systems often utilize Auto ID capture technology, such as barcode scanners, mobile computers, wireless LANs and RFID to efficiently monitor the flow of products. Once data has been collect, there is either a batch synchronization with, or a real-time transmission to, a central database. The database can then provide useful reports about the status of goods in the warehouse.

Although warehouse management systems provide reports showing status; they fail to provide any predictive capabilities. A need remains for a rules-based system that can analyze the data collected by the warehouse management system and provide alerts and warnings to prevent mishaps from occurring in the warehouse environment.

### SUMMARY OF THE INVENTION

The present invention includes a method of operating a warehouse that is based on when a condition related to location must cease. The present invention also includes a method of operating a warehouse that is based on a deadline. The present invention also includes a method of operating a warehouse that is based on quantity. The present invention also includes a method of operating a warehouse that is based on the organization of the warehouse. The present invention further includes a method for operating a warehouse that is based on the relative distances between objects within the warehouse. The present invention includes a method for operating a warehouse based upon the efficiency of assets within the warehouse.

Specifically, the present invention includes a method for operating a warehouse comprising the steps of: (a) providing a database server having a database, the database comprising real-time data related to a warehouse object at the warehouse, the real-time data including data regarding the location of the warehouse object and data regarding the time and date the warehouse object became resident at the location; the real-time data populated in the database by warehouse management software; (b) providing at least one rule related to when a condition of location for the warehouse object must cease, each rule having an associated trigger based on the lead time required to avoid violation of the rule; (c) receiving data related to said warehouse object at a computer; (d) predicting a potential violation of the rule by comparing, on the computer, the data regarding the time and date the warehouse object became resident at the location with the trigger; (e) generating an alarm related to the potential violation of the rule; and (f) providing the alarm to an operator.

In some embodiments of the present invention, the alarm is provided to the operator via a user device. The user device may be the monitor connected to the computer that predicts the potential violation of the rule. The user device may be a computer networked to the computer that predicts the potential violation of the rule. The user device may also be a cell phone, a handheld computer (e.g., a palm pilot or similar device), or a pager.

The alarm may comprise text. The alarm may comprise an audible component. The alarm may have both. The alarm may also comprise a visual component such as a flashing screen.

In some embodiments of the present invention, the data is received by the computer in real-time.

In some embodiments of the present invention, at least one rule is resident on the database server. In other embodiments of the present invention, all of the rules may be resident on the database server. In other embodiments of the present invention, all of the rules may be resident on a local computer. In still other embodiments of the present invention, at least one rule is resident on a local server. In other embodiments of the present invention, all of the rules may be resident on the local server.

Some embodiments of the present invention additionally comprise the step of taking action, based on the alarm, to prevent violation of the rule.

In some embodiments of the present invention, the warehouse has at least one bay at which a freight transportation vehicle interfaces with the warehouse, the rule is related to a duration that the freight transportation vehicle may interface with the warehouse at the bay, the associated trigger is related to a measure of time that is less than the measure of time associated with the rule, and the data represents when the freight transportation vehicle became resident at the bay.

In some embodiments of the present invention, the warehouse has at least one staging area for temporarily storing freight, the rule is related to a duration that the freight may be resident at a staging area, the associated trigger is related to a measure of time that is less than the measure of time associated with the rule, and the data represents when the freight became resident at the staging area.

In some embodiments of the present invention, the warehouse has at least one storage area for storing freight, the rule being related to a duration that the freight may be resident at a storage area, the associated trigger being related to a measure of time that is less than the measure of time associated with the rule, and the data represents when the freight became resident at the storage area.

The present invention also includes a method for operating a warehouse comprising the steps of: (a) providing a database server having a database, the database comprising real-time data related to a warehouse object at the warehouse, the real-time data including data regarding the location of the warehouse object and data regarding the time and date that the warehouse object became resident at the location, the real-time data populated in the database by warehouse management software; (b) providing at least one rule related to a time when a condition for the warehouse object must cease, each rule having an associated trigger based on a lead time to avoid violation of the rule; (c) receiving data related to the warehouse object at a computer; (d) predicting a potential violation of the rule by comparing, on the computer, the data regarding the time and date that the warehouse object became resident at the location with the trigger; (e) generating an alarm related to the potential violation of the rule; and (f) providing the alarm to an operator.

Some embodiments of the present invention additionally comprise the step of: obtaining the current time by the computer, the warehouse having at least one bay at which a freight transportation vehicle interfaces with the warehouse, the rule being related to a time the freight transportation vehicle must depart from a bay, the associated trigger related to a time earlier than the time provided in the rule, and the data being related to a freight transportation vehicle resident at the bay.

Some embodiments of the present invention additionally comprise the step of: obtaining the current time, wherein the warehouse has at least one staging area for temporarily storing freight, the rule being related to a time the freight must be removed from the staging area, the associated trigger related to a time earlier than the time provided in the rule, and the data being related to the freight resident in the staging area.

Some embodiments of the present invention further comprise the step of: obtaining the current time, wherein the warehouse has at least one storage area for storing freight, the rule being related to a time the freight must be removed from the storage area, the associated trigger related to a time earlier than the time provided in the rule, and the data being related to the freight resident in the storage area.

In some embodiments of the present invention, the alarm is provided to the operator via a user device. The user device may be the monitor connected to the computer that predicts the potential violation of the rule. The user device may be a computer networked to the computer that predicts the potential violation of the rule. The user device may also be a cell phone, a handheld computer (e.g., a palm pilot or similar device), or a pager.

The alarm may comprise text. The alarm may comprise an audible component. The alarm may have both. The alarm may also comprise a visual component such as a flashing screen.

In some embodiments of the present invention, the data is received by the computer in real-time.

In some embodiments of the present invention, at least one rule is resident on the database server. In other embodiments of the present invention, all of the rules may be resident on the database server. In other embodiments of the present invention, all of the rules may be resident on a local computer. In still other embodiments of the present invention, at least one rule is resident on a local server. In other embodiments of the present invention, all of the rules may be resident on the local server.

Some embodiments of the present invention additionally comprise the step of taking action, based on the alarm, to prevent violation of the rule.

The present invention also includes a method for operating a warehouse comprising the steps of: (a) providing a database server having a database, the database comprising real-time data related to a warehouse object at the warehouse, said real-time data including data regarding the quantity of the warehouse object, the real-time data populated in the database by warehouse management software; (b) providing at least one rule related to a condition of quantity for the warehouse object, each rule having an associated trigger based on a desired quantity of the warehouse object to maintain at the warehouse; (c) receiving data related to the warehouse object at a computer; (d) predicting a potential violation of the rule by comparing, on the computer, the data regarding the quantity of the warehouse object on hand with the trigger; (e) generating an alarm related to the potential violation of the rule; and (f) providing the alarm to an operator.

In some embodiments of the present invention, the rule is related to a minimum inventory level of the warehouse object to be maintained at all times within the warehouse, the associated trigger is related to an inventory level greater than the minimum inventory level, and the data is related to a current inventory level of the warehouse object and an order of the warehouse object.

In some embodiments of the present invention, the alarm is provided to the operator via a user device. The user device may be the monitor connected to the computer that predicts the potential violation of the rule. The user device may be a computer networked to the computer that predicts the potential violation of the rule. The user device may also be a cell phone, a handheld computer (e.g., a palm pilot or similar device), or a pager.

The alarm may comprise text. The alarm may comprise an audible component. The alarm may have both. The alarm may also comprise a visual component such as a flashing screen.

In some embodiments of the present invention, at least one rule is resident on the database server. In other embodiments of the present invention, all of the rules may be resident on the database server. In other embodiments of the present invention, all of the rules may be resident on a local computer. In still other embodiments of the present invention, at least one rule is resident on a local server. In other embodiments of the present invention, all of the rules may be resident on the local server.

Some embodiments of the present invention additionally comprise the step of increasing the inventory of the warehouse object, in response to the alarm, to prevent violation of the rule.

The present invention includes a method for operating a warehouse comprising the steps of: (a) providing a database server having a database, the database comprising real-time data related to warehouse objects at the warehouse, said real-time data including data regarding the location of the warehouse objects within the warehouse and data regarding the frequency that the warehouse object is used or picked from inventory, the real-time data populated in the database by warehouse management software; (b) providing at least one rule related to organizing the warehouse objects within the warehouse; (c) receiving data at a computer, the data related to a frequency that each warehouse object is picked; (d) comparing the data of each warehouse object, on the computer, to the data for each other warehouse object; (e) generating a proposal for organization of the warehouse objects within the warehouse based on the rule; and (f) providing the proposal to an operator.

Some embodiments of the present invention additionally comprise the step of relocating the warehouse objects within the warehouse in accordance with the proposal.

The present invention includes a method for operating a warehouse comprising the steps of: (a) providing a database server having a database, the database comprising real-time data related to a warehouse object at the warehouse, the real-time data populated in the database by warehouse management software, the warehouse having a plurality of bays at which freight transportation vehicles interface with the warehouse, said real-time data including data regarding the distance of the warehouse object from the bays; (b) providing at least one rule related to a condition of distance for the warehouse object relative to the bays; (c) receiving data related to the warehouse object at a computer; (d) comparing the data related to the distance of the warehouse object from the bays, on the computer, with the rule; (e) generating a proposal for directing a freight transportation vehicle to one of the plurality of bays based on the rule; and (f) providing the proposal to an operator.

The method may additionally comprise the step of directing the freight transportation vehicle to the bay identified in the proposal.

The present invention also includes a method for operating a warehouse comprising the steps of: (a) providing a database server having a database, the database comprising real-time data related to operation of the warehouse, said real-time data comprising data related to the performance of an employee in completing a task in the warehouse, the real-time data populated in the database by warehouse management software; (b) providing at least one benchmark performance target for at least one task related to operation of the warehouse; (c) receiving data related to an employee's performance of a task having an associated benchmark performance target at a computer; (d) comparing the data related to the employee's performance, on the computer, with the benchmark performance target; (e) generating a report comprising a rating for the employee's performance of the task based on the comparison; and (f) providing the report to an operator.

In one embodiment of the present invention, the benchmark performance target is related to an average time required to complete an associated task in the warehouse.

In one embodiment of the present invention, the data related to an employee's performance of a task is the time the employee took to complete the task.

In one embodiment of the present invention, the method additionally comprises the step of obtaining a plurality of ratings for different tasks performed by a plurality of employees and ranking each employee based upon their rating for each task.

In yet another embodiment of the present invention, the method additionally comprises the step of allocating an employee to a specific task based upon that employee's rating.

In addition to the novel features and advantages mentioned above, other objects and advantages of the present invention will be readily apparent from the following descriptions of the drawing(s) and preferred embodiment(s).

### BRIEF DESCRIPTION OF THE DRAWINGS

FIG. 1 depicts a schematic layout of a warehouse facility in accordance with one embodiment of the present invention.

FIG. 2 depicts a schematic layout of a staging area in accordance with one embodiment of the present invention.

FIG. 3 depicts a schematic layout of a storage area in accordance with one embodiment of the present invention.

FIG. 4a provides an illustration of the organization of a portion of the database used in accordance with one embodiment of the present invention.

FIG. 4b provides an illustration of the organization of a portion of a rules and trigger table used by a computer program in the practice of one embodiment of the present invention.

FIG. 5 provides a representation of the alarms appearing on the screen of a computer used in the practice of one embodiment of the present invention.

FIG. 6 provides a representation of the proposal related to the organization of the warehouse appearing on the screen of a computer used in the practice of one embodiment of the present invention.

FIG. 7 provides a representation of the proposal related to the bay assignment of a freight transportation vehicle appearing on the screen of a computer used in the practice of one embodiment of the present invention.

FIG. 8 provides a representation of the performance indexes for various employees for various tasks in appearing on the screen of a computer used in the practice of one embodiment of the present invention.

### DETAILED DESCRIPTION OF THE PREFERRED EMBODIMENT(S)

In accordance with the foregoing summary, the following presents a detailed description of the preferred embodiment(s) of the invention that are currently considered to be the best mode.

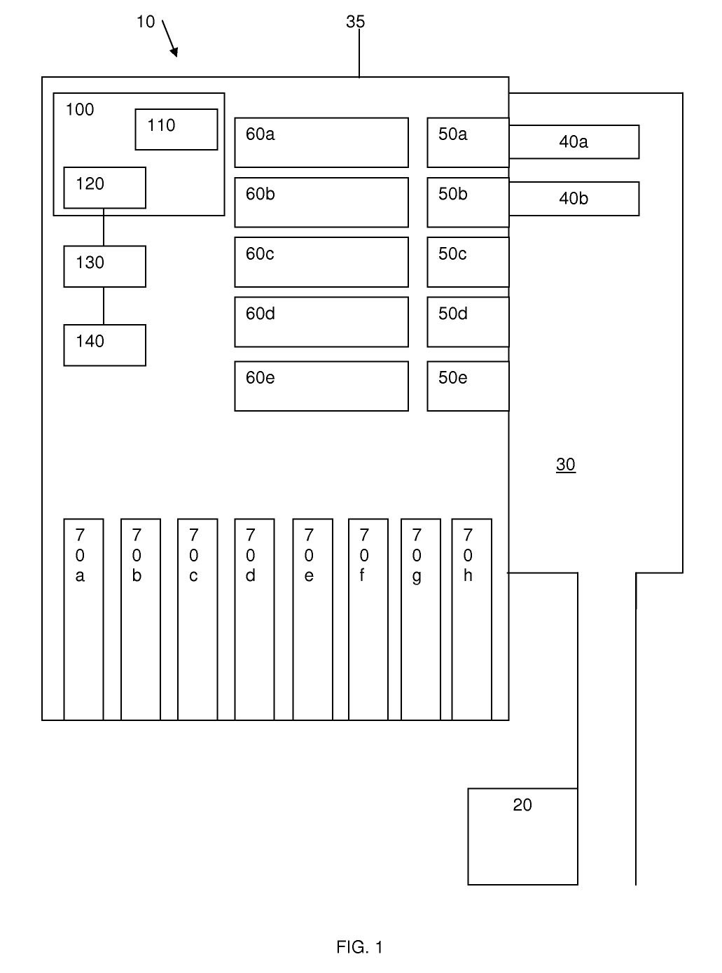

FIG. 1 depicts a schematic layout of a warehouse facility 10. Warehouse facility 10 has a gatehouse 20, a lot 30 and a warehouse 35. The warehouse is provided with a plurality of bays 50a-50e at which a freight transportation vehicle resident in lot 30 interfaces with the warehouse. Adjacent to each bay 50a-50e is an associated staging area 60a-60e. A staging area is a zone where the goods received from a freight transportation vehicle are temporarily placed, received into inventory and possibly re-organized prior to being transferred to storage areas 70a-70h. The staging areas also serve as zones where goods taken from storage areas 70a-70h are collected and readied for placement on a freight transportation vehicle.

The warehouse employs warehouse management software (WMS) for the collection of data related to goods and items in the facility. Accordingly, the warehouse 35 contains a database server 100 hosting the warehouse management software (WMS) 110 and a database of WMS data 120. Distributed throughout the warehouse facility are one or more computers 130 in communication with the database of WMS data 120. These computers are capable of receiving data stored in the database 120 either on-demand or in real-time. Additionally, an optional user device 140 may be in communication with any of the computers 130 so as to receive alerts, messages or other information compiled and processed by computer 130 relative to the operation of warehouse 35. The user device 140 may also provide a means for inputting data related to items in the warehouse.

Distributed throughout the warehouse are a plurality of RFID transponders (or scanners or other data collection technology) that communicate with tags (or labels) on goods within the warehouse environment so as to populate database 120 with data. For example, RFID transponders disposed at each bay gather data stored in the RFID tags affixed to the goods removed from a freight transportation vehicle as they are being transferred into the associated staging area. As such, the database is populated, in real-time, with data reflecting the identity of the good, the quantity of that good, and a time-date stamp indicative of when the data was gathered. These same RFID transponders are used to collect data on out-bound goods as well. For example, RFID tags on goods removed from a staging area and loaded onto a freight transportation vehicle are sensed by the RFID transponders which send data regarding the goods to database 120.

RFID transponders may also be deployed at the bay-side end of the staging area, the end of the staging area opposite the bay-side end, and throughout the storage areas. In this manner, data related to a goods identity, quantity and time-date stamp is collected at each location throughout the warehouse environment. As an alternative or complement to an RFID-based system, scanners, or any other suitable data-collection means, could be used to collect data regarding the identity, quantity and time-date stamp for a good at each relevant location (e.g., bay door, staging area, storage area, etc.) and provide the data to the database.

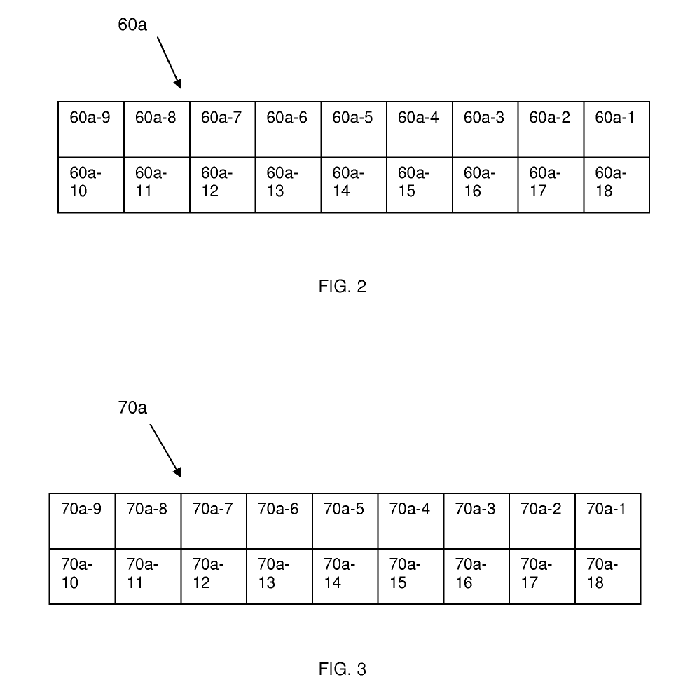

Furthermore, each staging area may be divided up into any number of sub-staging areas. As one example, FIG. 2 shows staging area 60a divided into 18 distinct sub-staging areas, 60a-1 through 60a-18. If the staging area is divided into two or more sub-staging areas, each sub-staging area may be outfitted with suitable data collection means.

Similarly, each storage area may be divided up into any number of sub-storage areas. As one example, FIG. 3 shows storage area 70a divided up into 18 distinct sub-storage areas, 70a-1 through 70a-18. If the staging area is divided into two or more sub-staging areas, each sub-staging area may be outfitted with suitable data collection means.

As a freight transportation vehicle approaches the warehouse facility 10, it checks in at gatehouse 20, where it is logged into the warehouse management system 110 through a computer located at the gatehouse before entering lot 30. The warehouse management system 110 collects data regarding the identity of the freight transportation vehicle, the time of arrival, and the bay to which the freight transportation vehicle is assigned. This data is stored in the database of WMS data 120.

After checking in at the gatehouse 20, freight transportation vehicle 40a proceeds to the assigned bay 50a. After the freight transportation vehicle 40a docks with bay 50a, data is collected regarding the vehicle situated at bay 50a including the time the vehicle became resident at the bay. This data is logged into the warehouse management system 110 and stored in database 120. Workers then begin unloading the goods contained in the freight transportation vehicle 40a. The identity of the workers unloading the goods may also be stored in the database. As the goods are removed from vehicle 40a and transferred into staging area 60a, data related to the goods (i.e., identity, quantity, time/date of receipt, etc.) is obtained and sent to the warehouse management system 110 for entry in database 120. In this manner, the database is provided with data regarding when a bay became occupied by a freight transportation vehicle, when a staging area first became occupied with goods, and when the last parcel was removed from the freight transportation vehicle.

The goods entering staging area 60a may be sorted to facilitate subsequent removal to the storage areas. Thus, goods of one type (e.g., pallets of white house paint) may be collected in a given sub-staging area, for example, 60a-1.

At some point, either while the freight transportation vehicle is being unloaded or after it has been completely unloaded, the goods placed in staging area 60a are transferred to the storage areas 70a-70h. As each good is removed from the staging area, data is captured that reflects the identity of the good, the quantity of the good and the time-date that the good left the staging area. This data is sent to the database. Furthermore, the worker responsible for removing the good from the staging area may also be captured and stored in the database.

As a good enters a storage area (e.g., 70b), data is again captured that reflects the identity of the good, the quantity of the good, and the time-date that the good entered the storage area. If the storage areas are divided into sub-parts, the data may reflect that the pallet of white paint was placed in 70b-5 at 2:15 pm on March 13. Furthermore, the identity of the worker responsible for introducing the good to the storage area may also be captured and stored in the database.

In order to fulfill outgoing orders, a worker collects the goods from the storage areas and compiles them at staging area 60b. As the individual goods are removed from storage, data is collected and sent to the database regarding the identity of the good, the quantity withdrawn, the time-date that the goods were withdrawn and, optionally, the identity of the worker responsible for their removal. As the goods enter staging area 60b, data is again collected and sent to the database. This data includes the identity of the goods, the quantity of the goods, the time-date that the goods were delivered to the staging area, and, optionally, the identity of the worker responsible for their delivery.

Once the order is assembled in staging area 60b, a freight transportation vehicle 40b situated at bay 50b receives the goods. As each good is removed from staging area 60b and placed within freight transportation vehicle 40b, data is collected and sent to the database regarding the goods identity, the quantity of the goods, the time-date that the goods left the staging area and were loaded onto the freight delivery vehicle and, optionally, the identity of the worker responsible for loading the freight transportation vehicle.

In this manner, the database is populated with information regarding the movement of goods throughout the warehouse environment in real-time.

A program resident on computer 130 receives the data stored in database 120 in real-time and compares the received data to triggers resident in the program to predict when a potential violation of a pre-set rule resident in the program may occur. In this regard, the warehouse's assets may be directed based on a predictive analysis of the status of the warehouse.

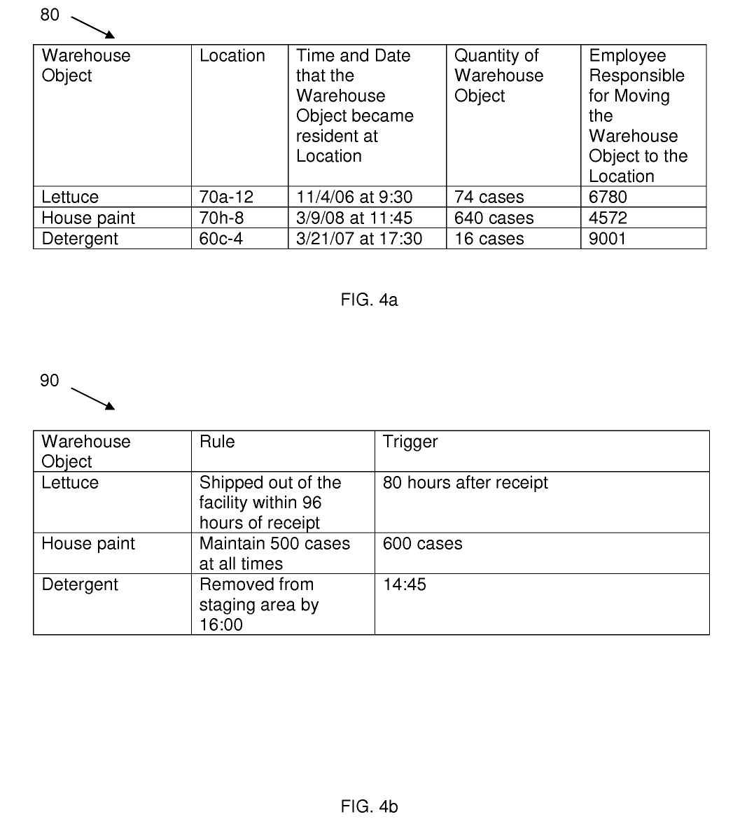

FIG. 4a presents a table 80 representative of the organization of at least a portion of the data collected and stored in database 120. As shown in FIG. 4a, each warehouse object is identified and accompanied by data regarding the location of the good within the warehouse, the time and date that the good became resident at that location, the quantity of the good on hand, and the employee responsible for placing the goods at the location.

FIG. 4b presents a table 90 representative of the rules and associated triggers used by a computer program in the practice of one embodiment of the present invention. As depicted in FIG. 4b, each warehouse object (or good) has an associated rule based upon the location of the good within the warehouse, the quantity of the good, or the desired retention time of the good at the warehouse. Each good may have multiple rules applied thereto based upon the nature of the good and the disposition (location/quantity) of the good within the warehouse.

For example, it may be necessary that a given staging area be cleared by 4 pm each day to facilitate shift change or the arrival of the next freight transportation vehicle at 4:30 pm. Accordingly, because it is known that a full staging area may be cleared of goods within 75 minutes if necessary, the trigger is set at 2:45 pm. Because the database has previously collected data regarding goods placed in the staging area and data regarding goods exiting the staging area, the program is able to determine if any goods remain in the staging area at a given time. If it is determined that goods remain in the staging area at 2:45 (the trigger), an alarm is generated warning that the rule (no goods in the staging area at 4 pm) may be violated. For example, the program may cause a message to appear on the monitor of the computer running the program that indicates that the staging area contains goods that require attention. Upon receipt, workers are directed to remove the goods from the staging area by 4 pm. When the goods are removed from the staging area, data is collected reflecting this and sent to the database. The program receives this information and updates the alarm to reflect that the staging area is clear and ceases to further broadcast the alarm. If however, the goods remain in the staging area past 4 pm, the program generates a second alarm. For example, the program may cause a message to appear on the monitor that indicates that the rule (staging area cleared by 4 pm) has been violated.

As another example, an item (such as lettuce) may have a limited shelf-life and it may be desirable to ship this item out of the warehouse within a certain time of being received. The rule could be that lettuce may remain at the warehouse for no more than 96 hours. A suitable trigger may be 80 hours, thereby allowing 16 hours to remove the lettuce from storage and arrange for the shipment of the lettuce out of the warehouse. The program would receive data regarding the time-and-date the lettuce was received at the warehouse and compare the elapsed time since the lettuce was received against the trigger to determine if an alarm should be issued. If the lettuce is resident at the warehouse for more than the 80 hours allowed by the trigger, then the program generates an alarm warning that the lettuce has been at the warehouse longer than is desirable. Upon receipt of the alarm, workers are directed to address the removal of the product from the warehouse by appropriate means.

As a third example, it may be necessary to maintain a certain inventory of a good in the storage areas of the warehouse to accommodate fluctuations in orders. The rule could be that the warehouse maintains at least 500 cases of a detergent at all times. The trigger could be set at 600 cases. As each case of detergent is introduced to the warehouse and as each case of detergent exits the warehouse, data is collected and sent to the database such that the total number of cases of detergent at any time is known. The program receives data regarding the inventory of detergent in the warehouse and compares it to the trigger of 600 cases. If the number of cases in inventory exceeds the trigger, the program takes no further action. However, if the number of cases is equal to or less than the quantity specified by the trigger, the program generates an alarm warning that the warehouse has an unsuitable quantity of detergent on hand. Upon receipt of such an alarm, workers are directed to increase the inventory of detergent.

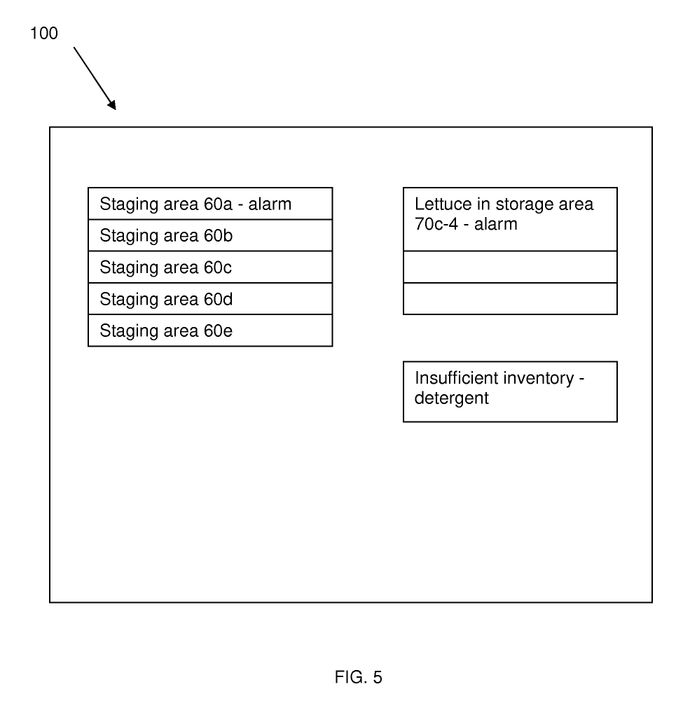

The program running on computer 130 displays the current condition of the item of interest on its screen such that a user is provided with a real-time indication of the condition in the warehouse. For example, as shown in FIG. 5, the program may present a warning on the screen 100 of the computer running the program that staging area 60a is likely to contain goods past 4 pm, that no issues exist with regard to staging areas 60b-60e, that the lettuce resident in storage area 70c-4 has been there for an excessive amount of time, and that the quantity of detergent in inventory is insufficient to meet the fluctuations experienced by the warehouse. In warning the operator, the program may employ color coding to alert the user to various conditions. For example, the program may use a yellow background to denote when a condition meets or exceeds a trigger and a red background to denote when a condition violates a rule. Alternatively, the program may send regular priority e-mail messages to user device 140 when a condition meets or exceeds a trigger and a high priority e-mail message when the condition violates the rule.

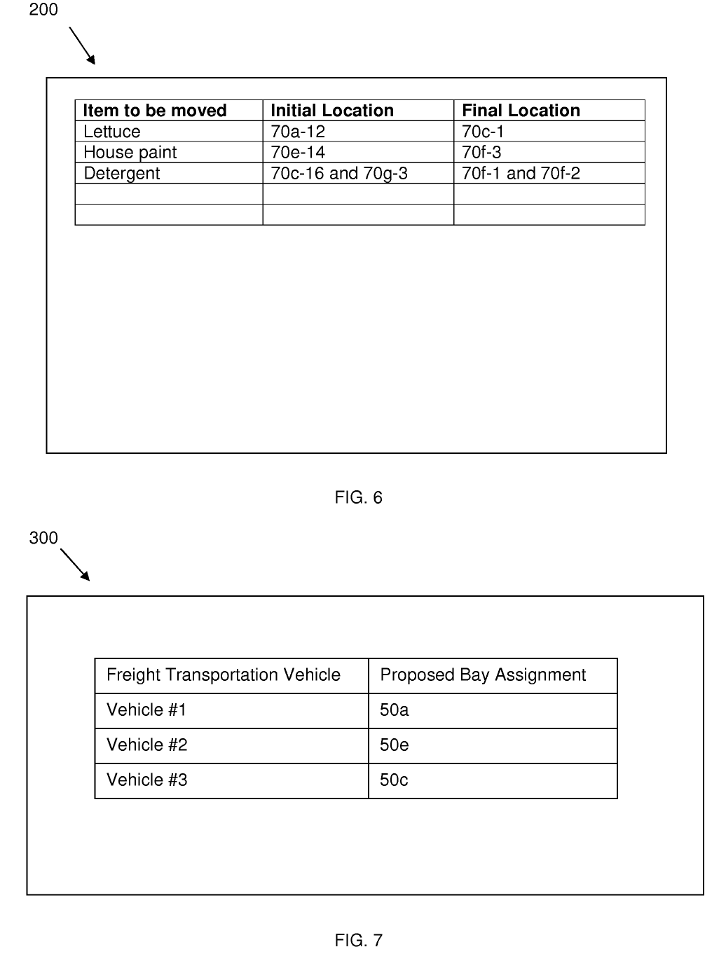

Additionally, the program can provide proposals for the organization of goods in the storage areas of the warehouse by comparing data for each good related to the frequency that the good is picked with a rule. In such cases, the rule may be such that high frequency items are to be located at the end of the storage areas closest to the staging areas and that low frequency items are to be placed as far away from the staging area as possible. The program running on computer 130 receives data from database 120 regarding the frequency that each type of good is picked from the storage area over a predetermined period of time (prior three weeks, etc.). The program may also receive data regarding the amount of space within the storage area that a given good utilizes. The program also receives data regarding the layout of the storage area (for example, number of rows of shelves) The data is sorted based upon the associated pick frequency for each good and a proposal is prepared for the distribution of goods across the storage area such that each row of shelves is organized with high-pick frequency items closest to the staging area while lower pick-frequency items are placed further from the staging areas in descending order. The proposal 200 is provided to the operator of the computer showing what goods need to be moved, the initial location of the goods and the destination of the goods as reflected in FIG. 6. Based upon the proposal, workers are directed to re-organize the storage area.

Furthermore, the program can provide a proposal for which bay to assign a freight transportation vehicle at the warehouse. Based upon data stored in the database regarding the location of goods within the warehouse structure and provided with data regarding the distance from various points within the storage areas of the warehouse, a proposal as to which of the plurality of bays to assign a freight transportation vehicle can be made. In such a situation, the rule is related to minimizing distance between the good to be loaded and the bay at which the freight transportation vehicle is located. The intent behind the rule is to reduce the transit time in moving the good from the storage area to the staging area associated with the bay at which the freight transportation vehicle is located. As the freight transportation vehicle enters the warehouse facility, it checks in at gatehouse 20 where it is logged into the warehouse management system 110. Data resident in database 120 identifies goods that the freight transportation vehicle is scheduled to pick-up. A program running on the computer in gatehouse 20, receives data regarding the location of the goods within the warehouse and the available unoccupied bays. The program compares the distance between each available unoccupied bay and the location of the good within the warehouse. A proposal 300 is then provided to the operator as to which bay to assign the freight transportation vehicle as shown in FIG. 7. Based upon this proposal, the freight transportation vehicle is directed to the bay.

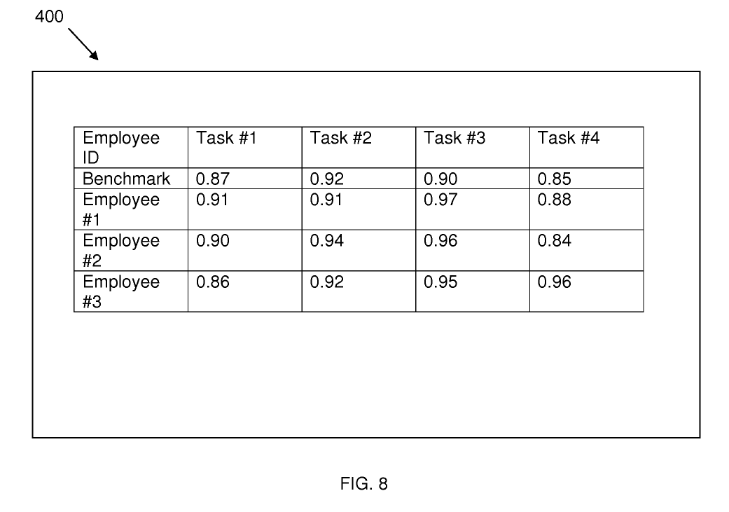

The program may also determine the efficiency of workers within the warehouse environment and provide a proposal 400 for the assignment of the workers as shown in FIG. 8. As each freight transportation vehicle is received and unloaded, data related to the goods entering the staging area is taken and delivered to the database. This data includes not only the time and date that the goods were moved, but also the identity of the worker responsible. A program running on computer 130, receives data regarding when unloading of the freight transportation vehicle started and completed and data regarding the quantity of goods on unloaded. Thus, the program can determine the time that it took to unload the freight transportation vehicle and who performed the task. By comparing the time versus the quantity of goods a performance index is determined for the individual performing the task. The program contains a benchmark performance target related to the task of unloading a freight transportation vehicle. The program generates a report comparing the performance of the individual to the benchmark target and provides it to an operator.

Similarly, benchmark performance targets are provided for each task within the warehouse. For example, the task of unloading a freight transportation vehicle, the task of removing the goods in a staging area and placing them in the storage area, the task of picking goods from the storage area and delivering them to a staging area, and the task of loading the goods in a staging area in a freight transportation vehicle. Performance indexes are generated for each employee for each task. In this manner, comparison of the performance index for each employee for a given task reveals who is the most efficient at that task. Based upon these rankings, an employee can be assigned to a specific task thereby directing resources in an efficient manner.

While the invention has been described in connection with what is presently considered to be the most practical and preferred embodiments, it is to be understood that the invention is not to be limited to the disclosed embodiment(s), but on the contrary, is intended to cover various modifications and equivalent arrangements included within the spirit and scope of the appended claims, which are incorporated herein by reference.

What is claimed is:

1. A method for operating a warehouse, said method comprising the steps of:
providing a database server having a database, said database comprising real-time data related a warehouse object at said warehouse, said real-time data including data regarding the location of said warehouse object and data regarding the time and date said warehouse object became resident at said location, said real-time data populated in said database by warehouse management software;
providing at least one rule related to when a condition of location for said warehouse object must cease, each said rule having an associated trigger based on a lead time required to avoid violation of the rule;
receiving said data related to said warehouse object at a computer;
predicting a potential violation of said rule by comparing, on said computer, said data regarding the time and date said warehouse object became resident at said location with said trigger;
generating an alarm related to said potential violation of said rule; and
providing said alarm to an operator.

2. The method according to claim 1 wherein said alarm is provided to said operator via a user device.

3. The method according to claim 1 wherein said alarm is audible.

4. The method according to claim 1 wherein said data is received by said computer in real-time.

5. The method according to claim 1 wherein at least one said rule is resident on said database server.

6. The method according to claim 1 wherein at least one said rule is resident on a local server.

7. The method according to claim 1 additionally comprising the step of taking action, based on said alarm, to prevent violation of said rule.

8. The method according to claim 1 wherein said warehouse has at least one bay at which a freight transportation vehicle interfaces with said warehouse, said rule is related to a duration that said freight transportation vehicle may interface with said warehouse at said bay, said associated trigger is related to a measure of time that is less than said measure of time associated with said rule, and said data represents when said freight transportation vehicle became resident at said bay.

9. The method according to claim 1 wherein said warehouse has at least one staging area for temporarily storing freight, said rule is related to a duration that said freight may be resident at a staging area, said associated trigger is related to a measure of time that is less than said measure of time associated with said rule, and said data represents when said freight became resident at said staging area.

10. The method according to claim 1 wherein said warehouse has at least one storage area for storing freight, said rule being related to a duration that said freight may be resident at a storage area, said associated trigger being related to a measure of time that is less than said measure of time associated with said rule, and said data represents when said freight became resident at said storage area.

11. A method for operating a warehouse, said method comprising the steps of:
providing a database server having a database, said database comprising real-time data related to a warehouse object at said warehouse, said real-time data including data regarding the location of said warehouse object and data regarding the time and date that said warehouse object became resident at said location, said real-time data populated in said database by warehouse management software;
providing at least one rule related to a time when a condition for said warehouse object must cease, each said rule having an associated trigger based on a lead time required to avoid violation of the rule;
receiving data related to said warehouse object at a computer;
predicting a potential violation of said rule by comparing, on said computer, said data regarding the time and date that said warehouse object became resident at said location with said trigger;
generating an alarm related to said potential violation of said rule; and providing said alarm to an operator.

12. The method according to claim 11 further comprising the step of: obtaining the current time by said computer, said warehouse having at least one bay at which a freight transportation vehicle interfaces with said warehouse, said rule being related to a time said freight transportation vehicle must depart from a bay, said associated trigger related to a time earlier than said time provided in said rule, and said data being related to a freight transportation vehicle resident at said bay.

13. The method according to claim 11 further comprising the step of: obtaining the current time, wherein said warehouse has at least one staging area for temporarily storing freight, said rule being related to a time said freight must be removed from said staging area, said associated trigger related to a time earlier than said time provided in said rule, and said data being related to said freight resident in said staging area.

14. The method according to claim 11 further comprising the step of: obtaining the current time, wherein said warehouse has at least one storage area for storing freight, said rule being related to a time said freight must be removed from said storage area, said associated trigger related to a time earlier than said time provided in said rule, and said data being related to said freight resident in said storage area.

15. The method according to claim 11 wherein said alarm is provided to said operator via a user device.

16. The method according to claim 11 wherein said alarm is audible.

17. The method according to claim 11 wherein said data is received by said computer in real-time.

18. The method according to claim 11 wherein at least one said rule is resident on said database server.

19. The method according to claim 11 wherein at least one said rule is resident on a local server.

20. The method according to claim 11 additionally comprising the step of taking action, based on said alarm, to prevent violation of said rule.

21. A method for operating a warehouse, said method comprising the steps of:
providing a database server having a database, said database comprising real-time data related to a warehouse object at said warehouse, said real-time data including data regarding the quantity of said warehouse object, said real-time data populated in said database by warehouse management software;
providing at least one rule related to a condition of quantity for said warehouse object, each said rule having an associated trigger related to a desired quantity of said warehouse object in said warehouse;
receiving said data related to said warehouse object at a computer;
predicting a potential violation of said rule by comparing, on said computer, said data regarding the quantity of said warehouse object with said trigger;
generating an alarm related to said potential violation of said rule; and
providing said alarm to an operator.

22. The method according to claim 21 wherein said rule is related to a minimum inventory level of said warehouse object to be maintained at all times within said warehouse, said associated trigger is related to an inventory level greater than said minimum inventory level, and said data is related to a current inventory level of said warehouse object and an order of said warehouse object.

23. The method according to claim 21 wherein said alarm is provided to said operator via a user device.

24. The method according to claim 21 wherein said alarm is audible.

25. The method according to claim 21 wherein said data is received by said computer in real-time.

26. The method according to claim 21 wherein at least one said rule is resident on said database server.

27. The method according to claim 21 wherein at least one said rule is resident on a local server.

28. The method according to claim 21 additionally comprising the step of increasing said inventory of said warehouse object, in response to said alarm, to prevent violation of said rule.

29. A method for operating a warehouse, said method comprising the steps of:
providing a database server having a database, said database comprising real-time data related to warehouse objects at said warehouse, said real-time data including data regarding the location of said warehouse objects within said warehouse and data regarding the frequency that said warehouse object is used, said real-time data populated in said database by warehouse management software;
providing at least one rule related to organizing said warehouse objects within said warehouse;
receiving data at a computer, said data related to a frequency that each said warehouse object is picked;
comparing said data regarding the location of each said warehouse object and said data regarding the frequency that each said warehouse object is used, on said computer, to data for each other said warehouse object;
generating a proposal for organization of said warehouse objects within said warehouse based on said rule; and
providing said proposal to an operator.

30. The method according to claim 29 further comprising the step of: relocating said warehouse objects within said warehouse in accordance with said proposal.

31. A method for operating a warehouse, said method comprising the steps of:
providing a database server having a database, said database comprising real-time data related to a warehouse object at said warehouse, said real-time data populated in said database by warehouse management software, said warehouse having a plurality of bays at which freight transportation vehicles interface with said warehouse, said real-time data including data regarding the distance of said warehouse object from said bays;
providing at least one rule related to a condition of distance for said warehouse object relative to said bays;
receiving data related to said warehouse object at a computer;
comparing said data related to the distance of said warehouse object from said bays, on said computer with said rule;
generating a proposal for directing a freight transportation vehicle to one of said plurality of bays based on said rule; and
providing said proposal to an operator.

32. The method according to claim 31 further comprising the step of: directing said freight transportation vehicle to said bay identified in said proposal.

33. A method for operating a warehouse, said method comprising the steps of:
providing a database server having a database, said database comprising real-time data related to operation of said warehouse, said real-time data comprising data related to the performance of an employee in completing a task in said warehouse, said real-time data populated in said database by warehouse management software;
providing at least one benchmark performance target for at least one task related to operation of said warehouse;
receiving data related to an employee's performance of a task having an associated benchmark performance target at a computer;
comparing said data related to said employee's performance, on said computer, with said benchmark performance target;
generating a report comprising a rating for said employee's performance of said task based on said comparison; and
providing said report to an operator.

34. The method according to claim 33 wherein said benchmark performance target is related to an average time required to complete an associated task in said warehouse.

35. The method according to claim 33 wherein said data related to an employee's performance of a task is the time said employee took to complete said task.

36. The method according to claim 33 additionally comprising the step of: obtaining a plurality of ratings for different tasks performed by a plurality of employees and ranking each said employee based upon their rating for each said task.

37. The method according to claim 33 additionally comprising the step of: allocating an employee to a specific task based upon said employee's rating.
